(19) United States
(12) Patent Application Publication
(10) Pub. No.: US 2003/0230427 A1
(43) Pub. Date: Dec. 18, 2003

(54) Surfaced cable filler

(76) Inventor: Galen Mark Gareis, Richmond, IN (US)

Correspondence Address: Lewis, Rice & Fingersh, L.C., Box IP Department, Suite 2000, 500 North Broadway, St. Louis, MO, 63102, US

(21) Appl. No.: 10/425,502

(22) Filed: Apr. 29, 2003

Related U.S. Application Data
(60) Provisional application No. 60/377,118, filed on May 2, 2002.

(51) Int. Cl. H01B 7/00

(52) U.S. Cl. 174/113 C

(57) ABSTRACT

Cables, methods of constructing cable, and other related systems, methods, and structures for forming cables such as category (e.g. CAT6) or other data cables which include a surfaced filler to keep the component cables in a predetermined arrangement during use. Further, these cables can be crushed and deformed from the predetermined arrangement, while still being able to return to it when the force is removed.

### CROSS REFERENCE TO RELATED APPLICATIONS

This Application claims priority to U.S. Provisional Patent Application Serial No. 60/377,118 filed May 2, 2002 the entire disclosure of which is herein incorporated by reference.

### BACKGROUND OF THE INVENTION

1. Field of the Invention

This disclosure relates to the field of electronic cables. In particular, to high speed data cables (category cables) and other cables that utilize fillers.

2. Description of the Related Art

Electronic devices, and computers in particular, are starting to become ever more connected. Just 20 years ago the idea of a computer network where machines talked with each other was simply a dream. Today, people from around the world are connected to computer networks which are both local (such as LANs) and worldwide in scope (such as the Internet).

As computers have become increasingly interconnected, there has arisen a more pronounced need for the cables and connectors used to connect them to be able to transfer more information in the same amount of time. While wireless networks have attracted a lot of attention recently, the vast majority of networks, and particularly of high speed networks, still communicate by sending electrical signals across conductors wired between them and therefore, as the networks push to be faster, the cables need to adapt to allow faster communication.

One particularly useful type of cable in the computer networking arena are the so-called “category” cables of which category 6 (or CAT6) is currently one of the standards utilized with category 5 or 5e (CAT5, CAT5e) also being used on a fairly regular basis. In category cable, it is necessary to meet certain performance characteristics set by standards setting organizations (such as the ISO or IEEE) for performance and attenuation cross-talk ratio (ACR). Generally, the higher the number of category cable, the more rigorous the requirements and the faster communication the cable is designed for. These standards are set so that networks utilizing the cable can operate and transfer at particular speeds without suffering from loss of data or other problematic concerns. In many respects, the standard defines the label. A CAT6 cable meets certain performance characteristics and therefore can be called “CAT6.”

The exacting standards required for data speed and electrical characteristics of CAT6 or higher cable relate in many cases to cross-talk in the cable. This includes near-end cross-talk (NEXT) and special categories such as far-end cross-talk (FEXT), and Power Sum NEXT (PSNEXT). Cross-talk is the interference in one channel from an adjacent channel and, in particular, relates to the cross-talk or signal interference between two component cables or wire pairs. Category cables generally utilize four component cables each of which is formed of a twisted pair. Each twisted pair comprises two individual conductors or wires (generally insulated from each other) which are twisted about each other to form a generally double helix shape. Over a length of the component cable, the shape of the twisted pair approaches a cylindrical shape.

Each of these component cables, and any other components included in the cable, are then encased in a jacket which forms the resultant cable. Cross-talk occurs when electrical impulses from one component cable (wire pair) can migrate to a different wire pair within this cable. That is, the component cables “talk” in a manner that is undesirable by sharing signals or allowing signals to finish propagating in a component other than the one in which they began propagating. Cross-talk can serve to corrupt data as in high-speed networks the loss or addition of electrical signals can cause the network to slow. Cross-talk is a significant concern in trying to build category cable because digital data which is propagated incorrectly can be misunderstood when received and therefore has to be re-sent and/or ignored. The problem is particularly acute in CAT6 cables as in CAT6 cables all four twisted pairs (component cables) are utilized for data transmission.

In many earlier cable designs, the insulation on each wire in the twisted pair was sufficient to prevent cross-talk between the component cables. The CAT6 standards are generally too rigorous, however, for this limited prevention and it is desirable to further insulate the twisted pairs from each other. Previously, twisted pair data cables (category cables) have tried to meet the controlled NEXT required for CAT6 cables by using “X”, “+”, or other cross-shaped fillers (or splines as they are sometimes called); round fillers; and/or elongated fillers which are placed within the cable jacket to separate the twisted pairs. All these designs have the same general layout. There are four twisted-pairs included in the cable which are arranged about the central filler. The four-twisted pairs are preferably arranged so that lines drawn between the center points of each non-adjacent twisted pair (effectively the centers of the cylinders they take up) form a cross, with the lines at generally right angles. This can be seen in FIGS. 6A and 6B.

When a cross-shaped filler is used, each twisted pair is placed in a single V formed by two-legs of the cross, placing the material of the filler between each twisted pair. In effect, the two neighboring twisted pairs are separated by a leg of the filler. The filler material (which is generally insulative) then serves to prohibit cross-talk between the different twisted pairs. In the circular (cylindrical) filler, the four twisted pairs are placed about a central circular filler. This provides sufficient elimination of cross-talk without significant increases in material by simply separating the twisted pairs a sufficient amount to prevent the cross-talk (as distance between the individual twisted pairs created by the filler can serve to isolate each twisted pair from the other twisted pair). These two prior art arrangements are shown in FIGS. 6A and 6B, respectively.

While these fillers have helped improve cross-talk characteristics, they are far from ideal. The round shaped filler can allow for movement of the twisted pairs relative to each other and failure of the cable to meet NEXT requirements with good capability when the cable is actually used. This is particularly true if the cable is compressed during its lifetime (such as when it is placed on a reel). Such compression is often a necessary step of cable manufacture, transport, or installation and therefore cables built using this type of filler, while suitable under ideal circumstances, are often rendered unusable under real world conditions. When pressure is placed on the cable, one or more of the four twisted pairs can rotate, slide, or roll about the circular filler and be in contact with a neighboring twisted pair. When the pressure is released, there are no forces present to return the moved twisted pair to its starting location, leaving the two components in contact with each other and failing to meet cross-talk requirements.

To visualize the problem, it is best to examine FIGS. 6B and 6C. The circular filler and component cables are arranged essentially as 5 cylinders in a cross-shape when the cable is correctly arranged. That is, there is a center cylinder filler with four cylinder cables in contact with its outer surface. The cylinders are arranged so that the opposing outer cylinders can have their center points connected by a line, and the two lines for the two pairs are perpendicular as shown in FIG. 6B. The construct is then contained inside a cover or jacket.

Because of the arrangement, putting pressure on one of the outside component cables can result in it sliding or rotating around the center filler and being pressed into a neighboring component cable (essentially deforming the cross) as shown in FIG. 6C. Because of the circular cross-section of the filler, the filler provides no resistance to this movement. In particular, the filler and jacket essentially form a hollow “race track” between themselves which the component cables can move around in. Movement is particularly problematic if the twisted pairs have slightly different diameters relative to each other as those with smaller diameters are easier to move. When the pressure is removed, the components do not return to their initial positions as there are no forces internal to the cable pushing them this way. In particular, as can be seen from FIG. 6C, any arrangement of the components can be a steady state. Therefore, at least two component cables are in contact and the physical separation is lost leading to a cable probably unable to meet the desired cross-talk characteristics as intended.

Cross-shaped fillers prevent the loss of geometric stability or shape present in the circular filler cables by keeping the twisted pairs separated by some of the filler material, even when compressed, but do so at the expense of over-correction. A cross-shaped filler prevents the motion of the component cables present in the circular filler case by placing a physical barrier between each of the component cables as can be seen in FIG. 5A. One such cross-shaped filler is described in U.S. Pat. No. 6,297,454, the entire disclosure of which is herein incorporated by reference. This barrier prevents cross-talk by physically preventing the component cables from even touching through the use of the physical barriers. However, this physical barrier is generally unnecessary for the prevention of CAT6 level cross talk, and therefore the compression protection places an unnecessary amount of material used within the resultant cable, as the physical barriers are extraneous. This unnecessary material makes the cross-shaped construction both more expensive and more difficult to manufacture. Further, because of the excess material within the cable, the resulting cable can have an increased fire risk and is necessarily more rigid and physically larger in construction than is necessary. These characteristics can make the cable less useful and harder to deal with.

It is therefore desired in the art to have a filler which can provide for geometric balance of the resulting cable, even if the cable is compressed, without having to have the expense or manufacturing difficulty of a filler that places a physical barrier between adjoining component cables.

### SUMMARY

Described herein are multi-part cables, methods of constructing multi-part cable, and other related systems, networks, and structures for forming cables, such as but not limited to, category cables (e.g., CAT6 cable) or other data cables, which include a surfaced filler. The surfaced filler will generally have a number of surfaces equal to or greater than the number of component cables used in the resulting multi-part cable.

Described herein, in an embodiment, is multi-part cable such as, but not limited to a category (e.g. CAT5, CAT5e, CAT6, CAT7, or CAT8) data cable, comprising: a number of component cables, the number of component cables being equal to or greater than two; and a surfaced filler having a longitudinal axis; wherein the filler has a number of separate surfaces extending down the longitudinal axis, the number of separate surfaces being equal to or greater than the number of component cables; and wherein each of the component cables rests against a different one of the separate surfaces.

In an embodiment, each of the component cables comprises a twisted pair of conductors which may be twisted into a double helix. In an embodiment, the surfaced filler has a cross-sectional shape of a polygon such as, but not limited to, a square. The separate surfaces of the surfaced filler may have a width less than the diameter of at least one of the component cables, may be flat, and/or may be concave.

In an embodiment, the multi-part cable may further include a jacket enclosing the surfaced filler and the at least two component cables and/or a shield which may enclose the surfaced filler and the at least two component cables, the shield being enclosed by the jacket or not.

In another embodiment there is described, a multi-part cable comprising: four component cables; a surfaced filler with a cross-sectional shape comprising a four-sided polygon; a jacket enclosing the at least four component cables and the surfaced filler; and, in an embodiment, a shield.

### BRIEF DESCRIPTION OF THE FIGURES

FIG. 1 provides a perspective view of an embodiment of a multi-part cable including a first embodiment of a surfaced filler. In particular, there is shown an unshielded category cable with four component cables (twisted pairs) and a square-shaped filler.

FIG. 2A provides a cross-sectional view of the multi-part cable of FIG. 1.

FIG. 2B provides a cross-sectional view of a multi-part cable similar to that of FIG. 2A, but this embodiment is a shielded cable.

FIG. 3 provides a cross-sectional view of a multi-layered multi-part cable including the embodiment of a surfaced filler shown in FIGS. 1 and 2.

FIG. 4 provides a cross-sectional view of a multi-part cable including a second embodiment of a surfaced filler.

FIG. 5 shows some general dimensional relationships in the embodiment of FIG. 2A.

FIG. 6 provides various examples of prior art multi-part cables.

### DESCRIPTION OF PREFERRED EMBODIMENT(S)

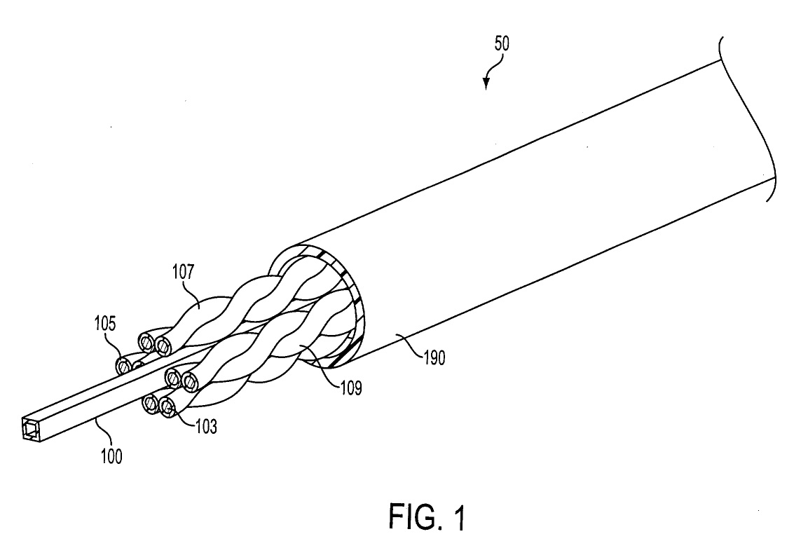

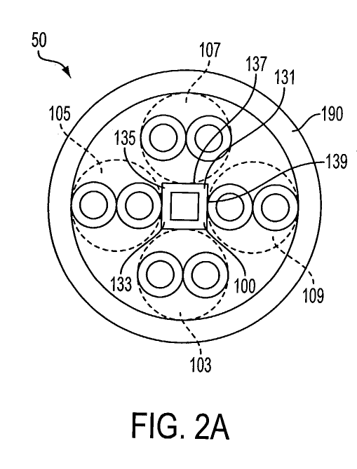

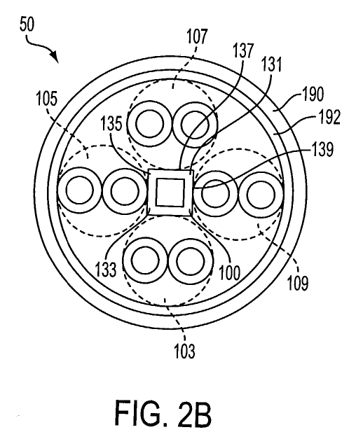

Disclosed herein, among other things, are multi-part cables such as category 5, 5e or 6 (CAT5, CAT5e or CAT6) cables or other data cable designs which include multiple component cables and a surfaced filler within a single jacket. In particular, each of these multi-part cables generally comprises at least two twisted pair data cables each of which is formed of two intertwined (generally as a double helix), individually insulated conductors (and possibly an external shield) and a surfaced filler having at least as many surfaces as there are component cables. The multi-part cable of a depicted embodiment of FIGS. 1 and 2 includes four such twisted pair component cables, therefore, the multi-part cable depicted has four component cables each of which comprises two conductors in a twisted pair. The multi-part cable also includes a surfaced filler having a number of surfaces generally equal to or greater than the number of component cables which in FIGS. 1 and 2 is at least four surfaces. Further, a single component cable preferably rests against a single surface. In this disclosure, the term component cable may refer to any conductor or series of conductors designed to function as a cable where multiple component cables are combined to form a multi-part cable.

While the embodiments described below discuss surfaced fillers which have four surfaces, one of ordinary skill in the art would understand how the principles, methods and designs disclosed herein can be incorporated into other cable fillers which have more than or less than four surfaces. The use of four surfaces is done as an exemplary and preferred embodiment. Further, one of ordinary skill in the art would understand that although the embodiments discussed herein are designed specifically for use with component cables which are constructed of four twisted pair conductors (such as CAT5, CAT5e, and CAT6 cables), the same principles, methods, and designs could be incorporated into other cables incorporating any number of twisted pairs (such as, but not limited to, any type of enhanced data cables) and/or cables utilizing component cables that are not in a twisted pair configuration and/or cables utilizing components which are not cables at all. Further, the principles and inventions disclosed herein may also be utilized on cables developed to meet new standards (such as, but not limited to, CAT7 or CAT8) when the standards for such cables are finally determined.

The embodiment of the invention provided in FIGS. 1 and 2A provides for a multi-part cable (50) comprising four component cables (103), (105), (107), and (109) and a surfaced filler (100) which are encased within a jacket (190). The embodiment of FIG. 2B includes the above components and also includes a shield (192) of any type known to those of ordinary skill in the art encasing the four component cables. Generally, the shield (192) will be constructed through known techniques. In some cases, the shield will be constructed by applying a thin and narrow sheet of metal (a metal tape), which may or may not be laminated or otherwise attached on a substrate such as, but not limited to, plastic. In another type of cable, the shield (192) is generated from a plurality of wires or other conductive components which are woven or braided together. In still other embodiments, shield (192) may comprise specific braided shields such as, but not limited to, a single braid, double braid, and/or “serve shield” as known to those of ordinary skill in the art, or a “French Braid” (double serve) as described in U.S. Pat. No. 5,303,630 to Gerald Lawrence, the entire disclosure of which is herein incorporated by reference. This braiding forms a tube of interlaced material which is electrically a single conductor and forms shield (192). In still another embodiment, the two methods may be used in combination such as a metal tape having a material braided thereon, vice-versa, or in multiple layers. In this case, the tape and braid together electrically form a single conductor and shield (192).

While FIG. 2B is the only FIG. showing an embodiment which incorporates a shield, any multi-part cable utilizing a surfaced filler could include a shield and the cables discussed herein could be either shielded or unshielded. For the purposes of simplicity, embodiments of unshielded cables are principally discussed in this document as a shielded cable is of generally similar construction with the addition of a shield.

The multi-part cable (50) is of generally cable shape, being an elongated cylinder. The surfaced filler (100) generally has a longitudinal axis which runs substantially the entire length of the elongated cylinder of the multi-part cable (50) with a predetermined number of separate surfaces (133), (135), (137), and (139) extending longitudinally down that axis. The component cables (103), (105), (107), and (109) then rest against the surfaces (133), (135), (137), and (139) along substantially the entire length of multi-part cable (50). This preferably gives the surfaced filler (100) a cross-section which is a geometric polygon or other surfaced shape such as that visible in FIGS. 2A, 2B, or 4.

The cross-section of the surfaced filler (100) may be hollow (as shown) or may be solid depending on the particular embodiment. The number of surfaces (133), (135), (137), and (139) is generally chosen so as to equal the number of component cables (103), (105), (107), and (109). In particular, in the embodiment of FIG. 1, the surfaced filler (100) has a cross-section comprising a four-sided figure such as a square as there are four component cables (103), (105), (107), and (109). In an alternative embodiment, there may be more surfaces on the surfaced filler (100) than there are component cables.

Each of the component cables (103), (105), (107), and (109) comprises a twisted pair of insulated conductors. In particular, component cable (103) includes insulated conductors (931) and (933), component cable (105) includes insulated conductors (951) and (953), component cable (107) includes insulated conductors (971) and (973) and component cable (109) includes insulated conductors (991) and (993). In FIGS. 2A and 2B, the insulated conductors (931), (933), (951), (953), (971), (973), (991), and (993) are shown in cross section at an instantaneous point along the longitudinal axis of the multi-part cable (50) and surfaced filler (100).

Associated with each component cable is a dashed circle. Circle (803) is associated with component cable (103), circle (805) is associated with component cable (105), circle (807) is associated with component cable (107) and circle (809) is associated with component cable (109). The dashed circle generally approximates the cross sectional shape of the twisted pair double helix over distance. It is important to recognize that each twisted pair essentially appears and behaves as a cylinder over the length of the cable (50) and therefore the behavior of cylinders as discussed herein also applies to the behavior of the component cables (103), (105), (107), and (109). Each component cable (103), (105), (107), and (109) is therefore essentially represented by the appropriate circle (803), (805), (807), or (809) and the behavior of such will be discussed.

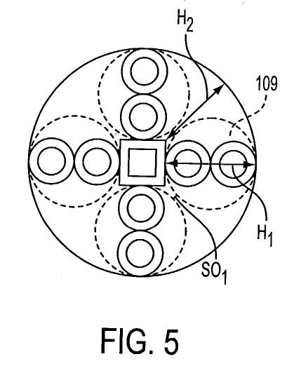

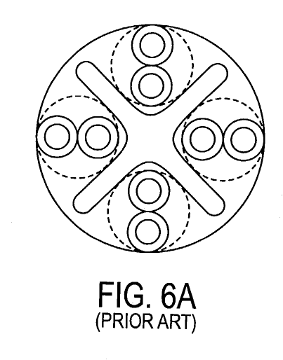

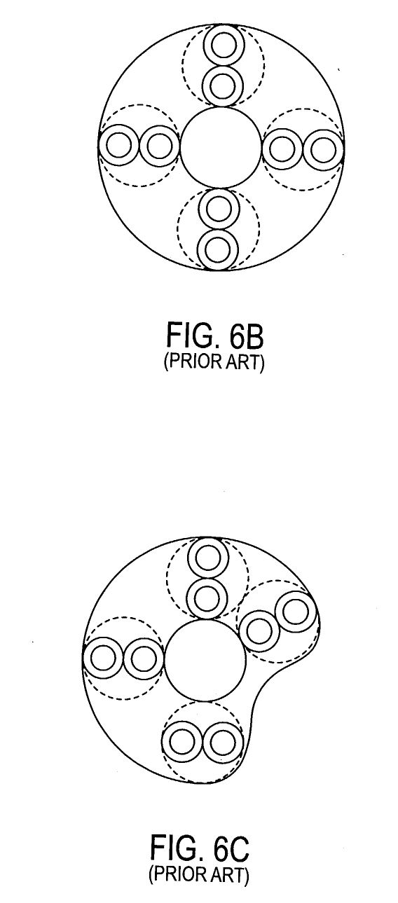

As shown in FIGS. 2A and 2B, the surfaced filler (100) is preferably sized and shaped so that all surfaces of the surfaced filler (100) are maintained within the space in the center of the component cables (103), (105), (107), and (109) as represented by circles (803), (805), (807), and (809). That is, the helixes would be allowed to contact each other as there is no material between adjacent twisted pairs (which is not to say that they do). Specifically, there is not material creating a physical barrier between the component cables (103), (105), (107), and (109) as in the cross-shape. To put this another way, if the closest points on each of the circles (803), (805), (807), (809) representative of the component cables (103), (105), (107), and (109) over the longitudinal axis were connected, the line (a representative line SO₁, is shown in FIG. 5) would not pass through any portion of surfaced filler (100). Preferably, the surfaced filler (100) is surrounded by the conductors (103), (105), (107) and (109) as also shown in FIG. 1.

So as to have at least as many surfaces as there are component cables, surfaced filler (100) preferably has a cross-section comprising a four-sided polygon (has four surfaces). It is further preferable that the polygon be selected so that the length of any side is generally of similar dimensions to other sides, but such a design is by no means required. This is preferred because it provides for a resulting layout of component cables (103), (105), (107), and (109) which is generally uniform in dimension which provides jacket (190) with a generally circular cross-section. One of ordinary skill in the art would understand that the surfaced filler (100) could have any polygonal cross-section depending on the number of desired surfaces, including, but not limited to, a quadrilateral shape (such as, but not limited to, a rectangle, parallelogram, trapezoid, trapezium, square, or rhombus), a polygon having fewer than four sides, and/or a polygon having more than four sides. The number of surfaces is generally only dependent on the number of component cables or other components present and the desired resulting arrangement of those components. Further, the geometric arrangement and length of those surfaces is not limited in any way.

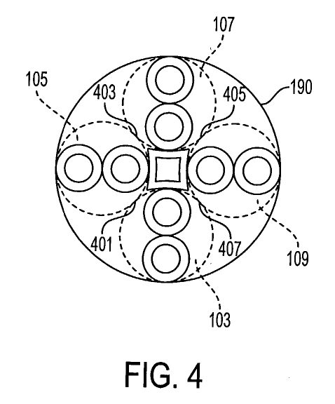

One of skill in the art would also understand that the cross-sectional shape need not be a polygon but could be any shape having sides or surfaces (133), (135), (137), and (139) which are linear, concave, convex, curved, shaped, or any combination thereof. One such alternative embodiment is shown in FIG. 4. The embodiment of FIG. 4 includes a surfaced filler (400) which has four concave surfaces (401), (403), (405) and (407). In the embodiment of FIG. 4, the size and shape of surfaced filler (100) is again chosen so that it provides at least one surface (side) for each twisted pair conductor in contact with it.

Because the surfaced filler (100) is surfaced as opposed to round, it provides for self alignment. Multi-part cable (50) is covered by a jacket (190) which serves to maintain the component cables (103), (105), (107), and (109) and surfaced filler (100) together in a single construct. When the multi-part cable (50) is compressed, the twisted pair conductors (103), (105), (107) and (109) cannot easily roll over the edge (such as edge (131)) of a surface (in this case surface (139)) as that motion is resisted by the jacket (190). A component cable would generally need to deform the jacket (190) to move in this manner. As can be seen in FIG. 5 presuming that the cylinder formed by the twisted pair over the longitudinal axis is of relatively unchangeable diameter, the twisted pair would need to fit through a space smaller than the one it currently occupies to change position. In particular, H₂ is less than H₁, as shown in FIG. 5 due to the surfaced filler (100). Therefore, when the cable is compressed, it still maintains the correct geometric orientation because the component cable (109) cannot pass through opening H₂ (or any similar opening). As shown in FIG. 5, as opposed to the circular filler which allows a “race track,” the surfaced filler creates instead a bottleneck at the joint between the surfaces.

Even if sufficient force is applied by the compression to deform the relationship (sufficient force to push the component cable (109) through the smaller space H₂), the cable may “self-repair” and return to its FIG. 2A configuration when the compression force is removed. It is preferable that each surface (133), (135), (137), and (139) have a width less than the diameter of any component cable (103), (105), (107), or (109) (represented by the diameter of circles (803), (805), (807), and (809) in this embodiment). Therefore two component cables cannot be simultaneously on the same surface unless the force was so great as to deform the overall shape of at least one component cable which is much more force than that generated by spooling the cable or other standard compression activities. In other words, the layout of components in FIG. 2A or 2B is a base arrangement to which the multi-part cable (50) will generally exist without the imposition of an outside force. Further, it is a shape to which the multi-part cable (50) will generally return when any outside forces are removed.

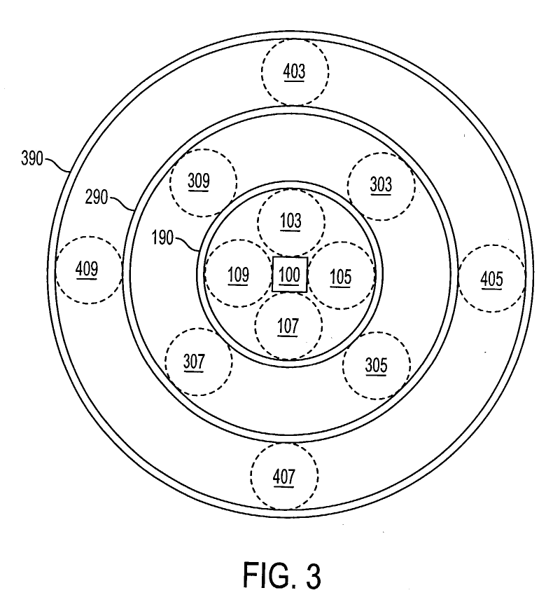

Further, as can be seen from FIG. 3, because of the nature of the multi-part cable (50) to resist deformation, the multi-part cable (50) can better maintain its shape for use in large cable arrangements and multiple layers. In this manner additional lay-up of additional twisted pair conductors can be placed using jacket (190) as a base. FIG. 3 shows one such built up cable (350) having two additional sets of conductors. The internal section of FIG. 3 is multi-part cable (50) as shown in FIG. 2A. The first set (layer) of conductors thereon is represented by component cables (303), (305), (307), and (309). The second set (layer) is represented by component cable (403), (405), (407), and (409). Each set of conductors may also be surrounded by a corresponding jacket (301) or (401). While FIG. 3 shows an embodiment where each of the two additional layers of twisted pairs includes four twisted pairs, one of ordinary skill in the art would understand that more or fewer twisted pairs could be used in either layer depending on design choice.

Since the surfaced filler (100) is generally smaller than a cross-shape filler, the core of the cable (50) includes less material (as there is no material physically separating the twisted pairs from each other as in the cross-shape; the “arms” have been eliminated). Because less material is used in the surfaced filler (100) compared to the cross-shape, fire compliance is more easily met generally leading to a safer cable for the same size. In addition, because material is removed from the surfaced filler (100) compared to a cross-shape, the cable (50) can be made smaller and more compact, as well as more flexible, which can allow it to be used in more applications.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A multi-part cable comprising:
a number of component cables, said number of component cables being equal to or greater than two; and
a surfaced filler having a longitudinal axis;
wherein said filler has a number of separate surfaces extending down said longitudinal axis, said number of separate surfaces being equal to or greater than said number of component cables; and
wherein each of said component cables rests against a different one of said separate surfaces.

2. The cable of claim 1 wherein each of said component cables comprises a twisted pair of conductors.

3. The cable of claim 2 wherein each of said twisted pair of conductors is twisted into a double helix.

4. The cable of claim 1 wherein said surfaced filler has a cross-sectional shape of a polygon.

5. The cable of claim 4 wherein said polygon is a square.

6. The cable of claim 1 wherein said number of component cables comprises four component cables.

7. The cable of claim 1 wherein said cable is a category data cable.

8. The cable of claim 7 wherein said cable comprises one of: a CAT5 cable, a CAT5e cable, a CAT6 cable, a CAT7 cable, and a CAT8 cable.

9. The cable of claim 1 wherein each of said separate surfaces has a width less than the diameter of at least one of said component cables.

10. The cable of claim 1 wherein at least one of said surfaces is flat.

11. The cable of claim 1 wherein at least one of said surfaces is concave.

12. The cable of claim 1 further comprising a jacket enclosing said surfaced filler and said at least two component cables.

13. The cable of claim 12 further comprising a shield enclosing said surfaced filler and said at least two component cables, said shield being enclosed by said jacket.

14. The cable of claim 1 further comprising a shield enclosing said surfaced filler and said at least two component cables.

15. A multi-part cable comprising:
four component cables;
a surfaced filler with a cross-sectional shape comprising a four-sided polygon; and
a jacket enclosing said at least four component cables and said surfaced filler.

16. The cable of claim 15 further comprising a shield.
